(19) United States
(12) Patent Application Publication
(10) Pub. No.: US 2007/0259322 A1
(43) Pub. Date: Nov. 8, 2007

(54) Breathing simulator for evaluation test of respirator

(75) Inventors: Hisashi Yuasa, Tokyo (JP); Takeshi Honda, Tokyo (JP); Kohsuke Nozaki, Tokyo (JP); Kazushi Kimura, Tokyo (JP)

Correspondence Address: DILWORTH & BARRESE, LLP, 333 EARLE OVINGTON BLVD., SUITE 702, UNIONDALE, NY, 11553, US

(73) Assignee: Koken Ltd., Tokyo (JP)

(21) Appl. No.: 11/787,415

(22) Filed: Apr. 16, 2007

(30) Foreign Application Priority Data
Apr. 17, 2006 (JP) 2006-113013

(51) Int. Cl. A62B 7/08

(52) U.S. Cl. 434/262; 128/202.26

(57) ABSTRACT

A breathing simulator for use in an evaluation test of respirators is provided, the breathing simulator being able to simulate larger respirations, undergoing a change neither in cycle nor in the amount of ventilation even in a test of respirators having a high pressure drop, able to easily generate not only such regular waveforms as a sine wave, a rectangular wave and a triangular wave but also respiration waveforms of workers and arbitrarily created waveforms as air waveforms, being reduced in size and power consumption, and easy to maintenance. The breathing simulator comprises plural air cylinders (1) for generating an air waveform, a single electric cylinder (2) for actuating the air cylinders, a servo controller (3) for controlling the operation of the electric cylinder, an input/output unit (4) for recording an analog input from the exterior and reproducing the recorded data at an arbitrary magnification, a PC (5) for creating an arbitrary waveform, and a waveform generator 6 for outputting the created waveform.

### FIELD OF THE INVENTION

The present invention relates to a breathing simulator or breathing pattern simulator for use in an evaluation test of respirators such as dust masks.

### BACKGROUND OF THE INVENTION

As evaluation test items for various respirators used in environments involving toxic gas and dust, there are various items, including measuring the efficiency of a filter medium and a pressure drop in a pulsating flow, evaluating the responsivity and air-tightness of a valve, and measuring an internal volume of a mask. It is known to use a breathing machine in such an evaluation test for respirators. However, the structure of breathing machines so far used in this type of application mainly adopts a method wherein a piston is reciprocated with a cam. Moreover, a ventilation condition in these breathing machines put in practical use is about 40 LPM per minute at most. Besides, the air waveform generated is only a sine wave. However, the actual respiration waveform of a worker is not a sine wave having certain amplitude and cycle, but varies greatly depending on the contents of a work, operation and environment. According to recent studies it has been reported that there actually is respiration corresponding to an instantaneous peak velocity of 300 to 500 LPM as a respiration condition of a worker. With conventional breathing machines, it is completely impossible to effect a performance inspection of a respirator under such a condition. In addition, there recently has been developed a new type of a respirator wherein the air volume from a blower provided within a mask is changed to match the respiration of a worker.

For properly evaluating the performance of a respirator it is necessary to conduct a test using respiration of a man actually. Since an apparatus capable of reproducing such a large and abrupt respiration as noted above is not available, a human test of a subject is performed in many cases. In the evaluation of a subject, since it is impossible to make the same respiration repeatedly, it is difficult to evaluate a variety of respirators in a relative manner. In the case of a respirator having a dust preventing function, the filter used becomes clogged as the respirator is used, which may result in a sudden increase of a pressure drop. In case of evaluating the respirator in such a state and at the foregoing respiration peak speed, it is presumed that a pressure drop of 2 kPa or more will result. Besides, the test system for evaluating the respirator requires a long piping and is complicated, so that it is also necessary to take air resistance into account.

In JP 3-18902B there is proposed a breathing machine having a mechanism using a cam to adjust the degree of opening of an air discharging/inhaling slit and capable of changing the resulting air waveform by adjusting the rotational speed of the cam. However, it is very difficult to generate an actual, ever-changing, human respiration waveform in terms of an air waveform and thus the breathing machine in question is unsuitable for evaluation of a respirator using a complicated waveform.

Also as to breathing simulators for artificial respirators, various such breathing simulators have been proposed (see, for example, JP 3329044B and JP 3683128B) and these breathing simulators may be applicable to the evaluation of respirators. However, these breathing simulators are for simulating respiration of a patient and do not cope with respiration quantities and peak speeds of workers working at various labor strengths, so are not suitable for evaluation of respirators.

### OBJECTS OF THE INVENTION

It is an object of the present invention to solve the problems of the conventional breathing machines and breathing simulators used in an evaluation test of respirators and particularly provide a breathing simulator for use in an evaluation test of respirators, the breathing simulator being able to simulate large respirations, undergoing a change neither in cycle nor in the amount of ventilation even in a test of a high pressure drop and being able to easily generate not only such regular waveforms as sine wave, rectangular wave and triangular wave but also respiration waveforms of workers and arbitrarily created waveforms as air waveforms.

### SUMMARY OF THE INVENTION

The present invention resides in a breathing simulator suitable for an evaluation test of respirators, the breathing simulator comprising a plurality of air cylinders for generating an air waveform, a single electric cylinder for actuating the air cylinders, and control means for controlling the electric cylinder in accordance with an inputted waveform.

According to the present invention there is provided a breathing simulator able to simulate larger respirations, undergoing a change neither in cycle nor in ventilation quantity even in a test of a high pressure drop, able to generate not only such regular waveforms as sine wave, rectangular wave and triangular wave but also arbitrary waveforms, able to reproduce and easily generate respiration in a work site, being reduced in size and power consumption, easy to maintenance, and suitable for an evaluation test of a respirator on the basis of respiration in a work site.

### BRIEF DESCRIPTION OF THE DRAWINGS

FIG. 1 is a block diagram showing an example of a breathing simulator according to the present invention.

FIG. 2 is a schematic process chart of an evaluation test of a respirator using the breathing simulator.

In the drawings, the numeral 1 denotes an air cylinders, numeral 2 denotes an electric cylinder, numeral 3 a servo controller, numeral 4 a data input/output unit, numeral 5 a personal computer (PC), numeral 6 a waveform output unit, numeral 7 a subject head, numeral 8 a test mask, numeral 9 a breathing simulator, numeral 10 a flowmeter, numeral 11 a gas or particle generator, numeral 12 a densitometer, numeral 13 an HEPA filter, numeral 14 a three-way valve, numeral 15 a pressure transducer and numeral 16 a recorder.

### EMBODIMENTS OF THE INVENTION

A preferred embodiment of the present invention will be described hereinunder with reference to the drawings.

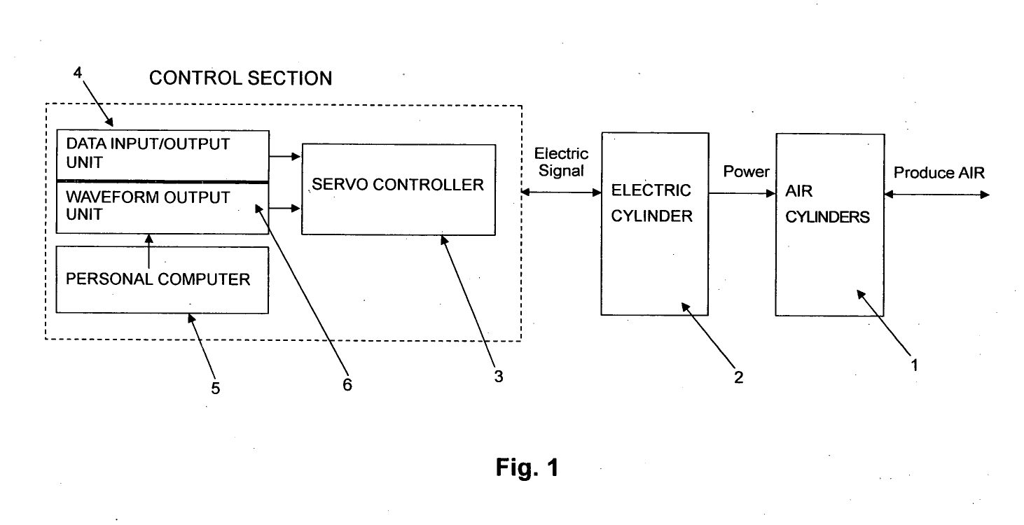

FIG. 1 is a block diagram showing an example of a breathing simulator for use in an evaluation test of a respirator according to the present invention.

This breathing simulator is made up of plural, preferably 2 to 5, air cylinders 1 for generating an air waveform, a single electric cylinder 2 for actuating the air cylinders, a servo controller 3 for controlling the operation of the electric cylinder, an input/output unit 4 for recording an analog input from the exterior and reproducing the recorded data at an arbitrary magnification, a personal computer PC 5 for forming an arbitrary waveform, and a waveform output unit 6 for outputting the waveform thus formed. The number of times of human respiration is considered to be about thirty times per minute even at most, but in the breathing simulator according to the present invention the number of times of respiration can preferably be controlled up to 180 times/min or more so as to permit creation of even very small respiratory oscillations. The ventilation quantity depends on the diameter of each air cylinder, but is usually preferably 50 to 140 mm. The number of air cylinders is two or more and it is preferable that the air cylinders used be able as a whole to generate at least 3.0 L or more per stroke. The cylinder stroke may be up to about 500 mm, but is suitably 300 mm or less.

A rated thrust of the electric cylinder corresponds to an increase of a pressure drop caused by a high air flow rate and so is preferably at least 0.5 KN. A rated speed of the electric cylinder is preferably 200 mm/sec or higher, more preferably 300 mm/sec or higher. In the case where the electric cylinder is replaced by a hydraulic cylinder, the system becomes large-sized and difficult to move because the hydraulic type requires a hydraulic oil source, labor is required for maintenance because it is necessary to replace hydraulic oil and element, and the power consumption required by the hydraulic oil source is about 10 KW which is high as compared with 0.75 to 1.5 KW in the electric cylinder. Thus, it is impossible to achieve the foregoing object and effect of the present invention.

In the breathing simulator according to the present invention, since there is adopted a method wherein plural air cylinders are operated by an electric cylinder controller with a servo controller to generate air, there is obtained an air waveform of a high air flow rate at the same stroke and without enlarging the diameter of each air cylinder. Particularly, since plural air cylinders are operated, it is possible to reduce the air cylinder diameter and generate air of a high accuracy even in the same amount of air. Moreover, in controlling the electric cylinder in this breathing simulator, the control is performed by making the stroke speed and voltage proportional to each other, whereby a worker's respiration waveform recorded and a waveform created on a personal computer can be reproduced with a high accuracy.

A further description will now be given about main constituent members of the breathing simulator according to the present invention. The air cylinders play the role of generating air and the electric cylinder and the air cylinders are connected together mechanically at respective cylinder rods. The stroke of the electric cylinder and that of the air cylinder rods are the same. Air is generated by extension and retraction of the air cylinder rods. As to the force required for extension and retraction of the air cylinder rods, the lighter, the better. For the prevention of deterioration, hydraulic oil such as grease is usually employed in the cylinders. In an evaluation test of a respirator, however, there sometimes is a case where organic or inorganic gas is used and therefore, for the purpose of making a gas concentration measurement correctly, it is preferable not to use grease or use hydraulic oil having little volatility such as silicone or fluorine-based vacuum grease.

The electric cylinder usually has a structure such that the cylinder rod thereof is extended and retracted with a rotational force of a motor. The rotation of the motor is controlled with an encoder for example and the cylinder stroke is controlled in the unit of 0.1 mm. The torque (thrust) of the motor and the speed of stroke are important performance items of the electric cylinder. The higher the thrust, the stronger the force of extension or retraction, whereby, insofar as the purpose of use of the breathing simulator according to the present invention is concerned, an exact waveform is obtained even in the case of a specimen of a high air flow resistance. Speed determines the speed of extension or retraction. Usually, the stroke speed of the electric cylinder is predetermined, but in the present invention it is preferable that the cylinder be able to reciprocate thirty times per minute for a minimum stroke of 300 mm. As the stroke is shortened, the number of times permitting reciprocation increases. The stroke corresponding to oscillations of 300 times/min is several millimeters.

The servo controller controls the electric cylinder and causes the electric cylinder to operate at preset stroke, frequency and waveform. Usually, the control is performed with pulses by use of an encoder, but there may be used a position sensor or the like. In this case, not a control made by proportioning voltage and cylinder position to each other, but a control made by proportioning voltage and stroke speed to each other is preferred. It is preferable to control the electric cylinder at 0-5V so that 0V=maximum retracting speed, 2.5V=zero speed, and 5V=maximum extending speed.

The data input/output unit inputs and stores a voltage waveform resulting from conversion of a respiration waveform on the basis of pressure and flow rate. A waveform signal hereof functions to transmit the waveform to the servo controller. When outputting the waveform, it is possible to increase or decrease the waveform.

Here, the recorded waveform can be outputted as it is without requiring such a troublesome processing as calculation of data whose volume is apt to become vast. Thus, the breathing simulator according to the present invention is suitable for checking the operation of devices or for evaluation of respirators on a laboratory level.

A waveform is created and transferred with use of the personal computer. More specifically, an arbitrary waveform is created using Excel or a waveform creating software and the data thereof is inputted to the waveform output unit (e.g., CSV format).

Here it is possible to perform not only a mere waveform creation but also, for example, introduce a flow rate waveform and a pressure waveform of a worker sampled in a work site or the like into the personal computer, perform calculation and send the resulting waveform to the waveform output unit. (In many cases the flow rate waveform and pressure waveform of a worker obtained by sampling do not directly correspond to the amount of respiration and therefore the flow rate waveform and the pressure waveform are converted to a speed waveform of respiration.)

Using these elements, it is possible to effect evaluation of a respirator (mask) through respiration of a worker in an actual work site. The waveform data transferred from the personal computer is outputted as a voltage waveform in the waveform output unit.

Preferably, the amplitude, cycle and the number of times of repetition, of that voltage waveform can be set arbitrarily.

The contents of an evaluation test of a respirator to which the breathing simulator according to the present invention is applied are not specially limited. As noted earlier, measuring the efficiency of a filter medium and a pressure drop in a pulsating current, evaluating the responsivity and air-tightness of a valve and measuring an internal volume of a mask are included in the aforesaid contents.

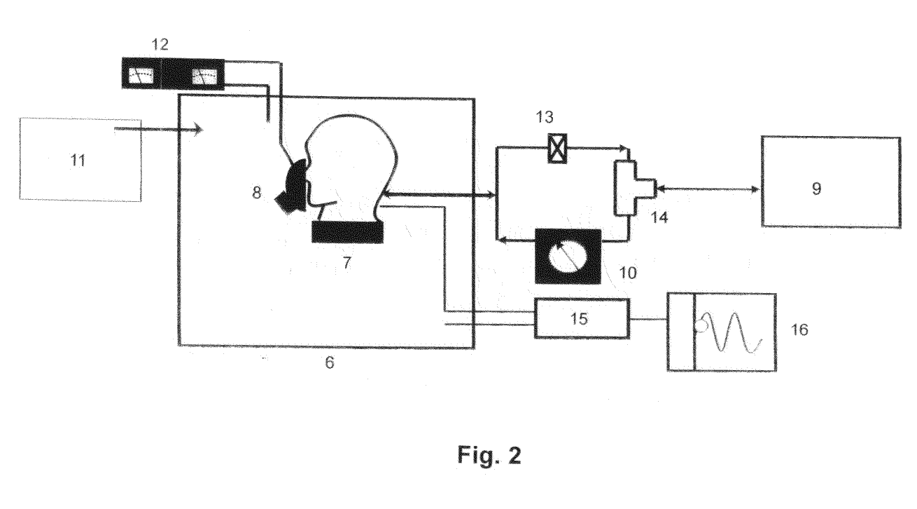

FIG. 2 is a schematic flow chart of a test for evaluation of a mask using the breathing simulator according to the present invention.

A test mask 8 is attached to a subject head 7 installed within a test chamber 6 to which gas or particles are supplied, and intake and exhaust are performed by a predetermined number of times of ventilation with use of the breathing simulator indicated at 9 according to the present invention. The amount of ventilation is checked with a flowmeter 10. The intake and exhaust are connected to the mouth and nose of the subject head, simulating a state in which a man wears a mask in a harmful environment. A harmful substance concentration in the test chamber and that in the test mask are measured with a densitometer to determine the performance of the mask. Further, by measuring a pressure difference between the inside and the outside of the mask with use a differential pressure gauge it is possible to determine an intake resistance and an exhaust resistance of the mask. The numeral 11 denotes a gas or particle generator, numeral 12 denotes a densitometer, numeral 13 an HEPA filter, numeral 14 a three-way valve, numeral 15 a pressure transducer, and numeral 16 a recorder.

What is claimed is:

1. A breathing simulator for use in an evaluation test of respirators which comprises a plurality of air cylinders for generating an air waveform, a single electric cylinder for actuating said air cylinders, and a control means for controlling said electric cylinder in accordance with an inputted waveform.

2. A breathing simulator as set forth in claim 1, wherein said control means comprises a servo controller for controlling the operation of said electric cylinder, an input/output unit for recording an analog input from the exterior and reproducing the recorded data at an arbitrary magnification, a PC for creating an arbitrary waveform, and a waveform generator for outputting the created waveform.

3. A breathing simulator as set forth in claim 1, which is used for an evaluation test of one or more respirators through respiration of a worker in a work site.
